(19) United States
(12) Patent Application Publication
(10) Pub. No.: US 2009/0114632 A1
(43) Pub. Date: May 7, 2009

(54) Remote control operated heater for water sports garments

(75) Inventor: Min-Chen Shiue, I-Lan Hsien (TW)

Correspondence Address: LEONARD TACHNER, A PROFESSIONAL LAW;CORPORATION, 17961 SKY PARK CIRCLE, SUITE 38-E, IRVINE, CA, 92614, US

(73) Assignees: Shei Chung Hsin Ind. Co. Ltd.; Top-Bound Enterprise Co., Ltd.

(21) Appl. No.: 11/982,855

(22) Filed: Nov. 5, 2007

(51) Int. Cl. H05B 11/00

(52) U.S. Cl. 219/211

(57) ABSTRACT

An aquatic garment-heating device employs a conductive rubber-heating device, which obviates the troublesome wiring of the prior art heating devices. It also employs a wireless switch control, which provides a number of advantages. By using a wireless switch, the on/off mechanism for activating or deactivating the heater, may be worn on a diver's wrist where it can be readily located when needed without requiring wires hanging in inconvenient places. Moreover, because the wireless switch may be located in plain view, rather than hidden in a pocket for example, it may be implemented with meaningful visual devices to convey useful information about the status of the heater. For example, in the preferred embodiment, an observable light provides various different colors to indicate whether the heater is in a low, medium or high temperature condition. Finally, the present invention uses especially thin profile batteries and heating elements to preclude any discomfort for the user. An alternative embodiment is provided on an external, detachable belt, which may still employ the wireless switch and thin profile heating element and batteries, but in an implementation, which permits the diver to add a heating system to an otherwise conventional wetsuit.

### BACKGROUND OF THE INVENTION

1. Field of the Invention

The present invention relates generally to the field of water sports garments such as scuba diver's wetsuits. The invention relates more specifically to a remote control operated heater used in a water sports garment.

2. Background Art

Heaters in water sports garments such as wetsuits for scuba divers, are not new. For example, published U.S. Patent Application 2007/0045269 discloses a heating garment having a back section with an electric heating element powered by a portable power source such as batteries. The garment may be used on land as well as in water. However, there are a number of disadvantages associated with such prior art heating garments. For example, the heating device itself is typically not made of an electrically conductive material. Therefore, wires must be employed to carry an electrical current through the heater to generate the requisite heat. Such wires tend to be fairly thick to carry enough current and such thick wires can be felt through the garment, thereby rendering the garment uncomfortable and even irritating adjacent the heating device.

Another significant disadvantage of such prior art relates to control of the heater by means of a wired switch. The wired switch is normally hidden in a pocket or left hanging where it may be inconvenient to locate. Moreover, such switches tend to be simple on/off type which do not provide any significant information or feedback regarding the condition of the heater.

### SUMMARY OF THE INVENTION

The present invention comprises an aquatic garment-heating device, which overcomes or substantially reduces the noted deficiencies of the prior art. Its preferred embodiment employs a conductive rubber-heating device, which obviates the troublesome wiring of the prior art heating devices. Such heating devices may be provided in virtually any shape such as triangular, or oval, or more complex shapes which better conform to human body geometry. It also employs a wireless switch control, which provides a number of advantages. By using a wireless switch, the on/off mechanism for activating or deactivating the heater, may be worn on a diver's wrist where it can be readily located when needed without requiring wires hanging in inconvenient places. Moreover, because the wireless switch may be located in plain view, rather than hidden in a pocket for example, it may be implemented with meaningful visual devices to convey useful information about the status of the heater. For example, in the preferred embodiment, an observable light provides various different colors to indicate whether the heater is in a low, medium or high temperature condition. Finally, the present invention uses especially thin profile batteries and heating elements to preclude any discomfort for the user.

An alternative embodiment is provided on an external, detachable belt, which may still employ the wireless switch and thin profile heating element and batteries, but in an implementation, which permits the diver to add a heating system to an otherwise conventional wetsuit. Another, hybrid belt arrangement places the heating elements in the garment, but places the batteries and electronics on a belt which can be, in effect, “plugged in” to the wetsuit at or near the heating elements to complete the heating system when needed. This hybrid belt system permits quick battery replacement using multiple belts between battery recharging. The batteries used herein are preferably Li-ion polymer rechargeable types which can store considerable amounts of energy in a relatively flat and unobtrusive profile and be re-charged hundreds of times.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a front view of a wetsuit using a heating system of the present invention;

FIG. 2 is a rear view of the wetsuit of a FIG. 1;

FIG. 3 is a plan view of a remote control for the heating system of FIG. 1;

FIG. 4 is a view of the remote control of FIG. 3 shown on a wristband;

FIG. 5 is a heating belt version of the invention; and

FIGS. 6 and 7 are vest versions of the invention.

### DETAILED DESCRIPTION OF PREFERRED EMBODIMENTS

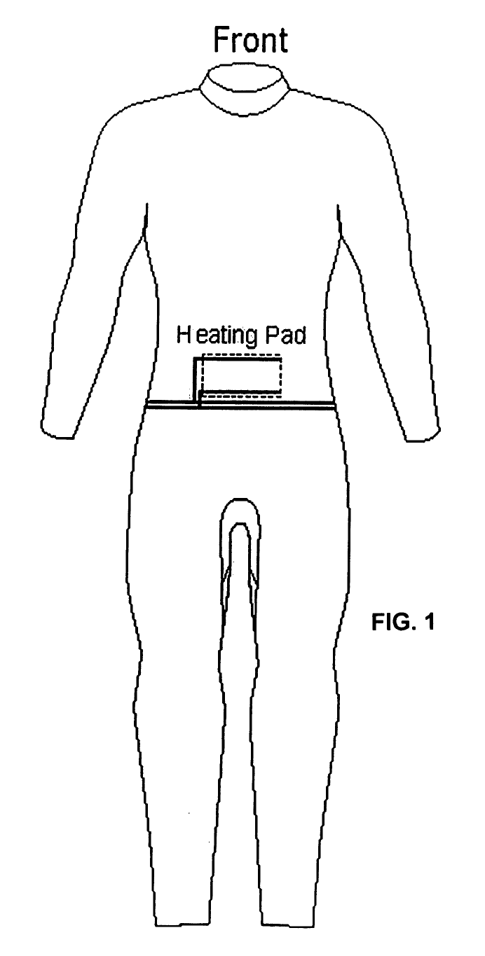

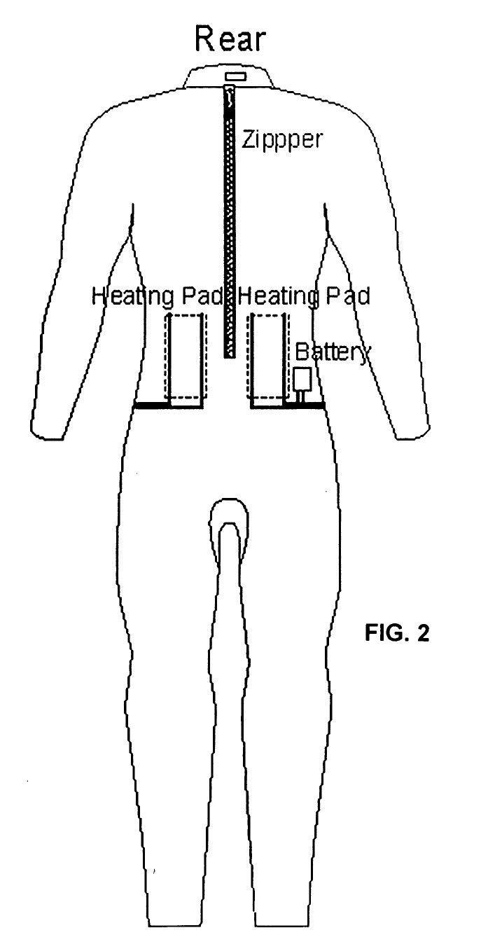

As shown in FIGS. 1 and 2, the heating pad elements of the preferred wetsuit embodiment are located in both the front and back portions of the wetsuit. The wiring that interconnects the battery and the heating pads, is preferably routed horizontally adjacent the user's waist to minimize any impact on comfort. Each pad is preferably made of a conductive rubber or elastomer sheet in a thickness of about one quarter inch maximum. The battery is preferably a rechargeable polymer Li-ion type which may be provided in very thin configurations and yet be capable of many Amp-hours of energy at 3.7 Volts at a cost of less than $5.00 per Amp-hour. Such batteries are normally rechargeable through at least 500 cycles and can provide enough energy for maximum heating up to at least two hours before requiring a recharging.

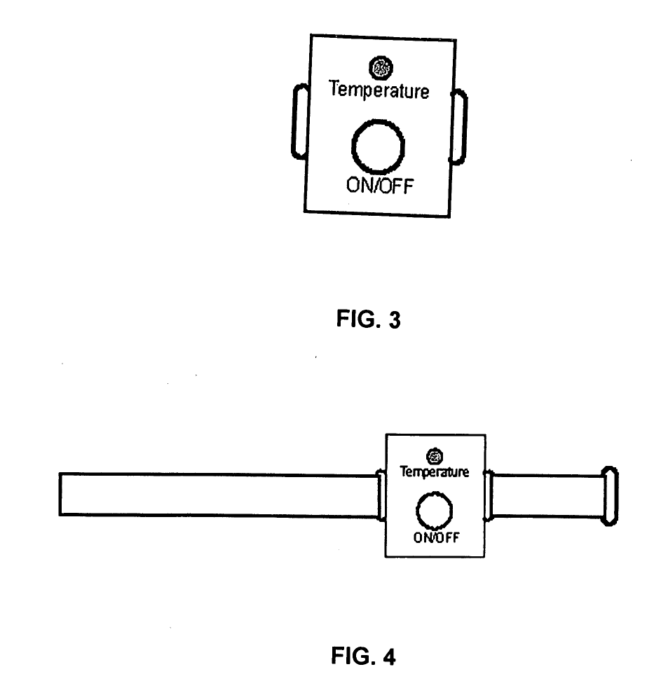

As shown in FIGS. 3 and 4, the application of battery power to the heating pad elements is preferably controlled by a wireless switch worn on a user's wrist. In the preferred embodiment, the wireless remote control communicates with the wetsuit components using an RF (radio frequency) link to control on/off and to choose any one of three temperature settings. A tri-color LED light indicates which setting has been selected; i.e., green for low (45 to 50° C.), yellow for medium (51 to 55° C.) and red for high (56 to 60° C.).

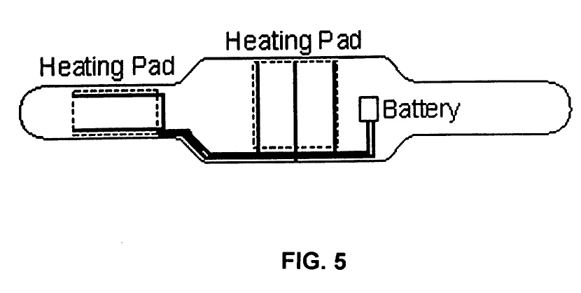

FIG. 5 illustrates another embodiment of the invention wherein the heating pad elements for both front and back locations are installed on a belt along with the battery power source. This embodiment also provides wireless remote switching using the remote control of FIGS. 3 and 4. The belt embodiment of FIG. 5 permits a diver to wear a conventional wetsuit and yet still have the benefit of electrical heating pad elements to gain comfort in very cold water.

The belt configuration of FIG. 5 may be modified to provide an alternative hybrid configuration wherein the heating pads are retained in the wetsuit and the belt is employed primarily to hold an abundant supply of batteries. This hybrid belt version would employ snap-type electrical contacts to connect the battery (or batteries) to the heating pad elements through a wireless switch.

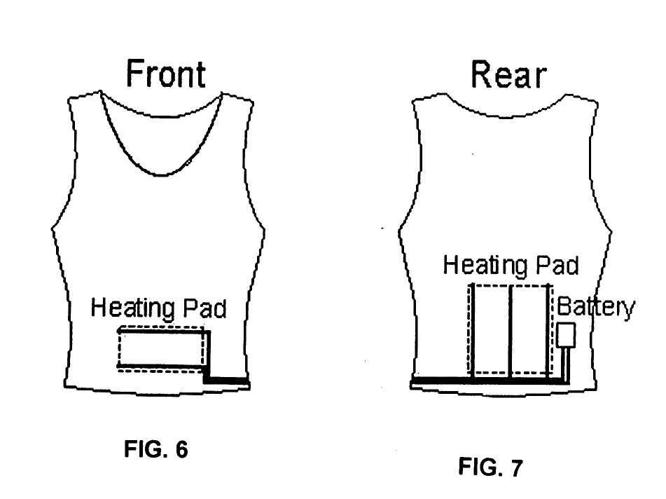

Still another embodiment of the invention is shown in FIGS. 6 and 7, which provide front and rear views, respectively, of a heating vest configuration. Because this vest may be worn underneath a wetsuit, it is especially advantageous to employ a wireless ON/OFF switch worn on a wrist of a diver to control the heating pad elements. Without the wireless remote control feature of the present invention, a wired ON/OFF and temperature control device would have to be routed through the wetsuit outside the vest to be accessible to the diver.

Thus, it will be understood that the present invention provides a more comfortable, more accessible wetsuit heater as compared to the relevant prior art. A principal feature of each of the described embodiments is a remote control ON/OFF and temperature control device which operates using wireless technology such as RF, such as at a frequency of 5.1 GHz using a form of pulse code modulation. The remote control device is shown as a wrist worn device, but may be locate at any convenient and observable location such as on the ankle or waist. An add-on belt embodiment has also been disclosed, which may have heating pad elements and batteries. Conductive rubber heater devices permit heater shapes other than rectangular only such as oval, triangular or complex.

Based upon the foregoing, it will now also be understood that various modifications and additions may be made to the illustrative embodiments disclosed herein. Accordingly, the scope hereof is to be limited only by the appended claims and their equivalents.

I claim:

1. A wetsuit heater apparatus comprising:
at least one heater pad element positioned in a wetsuit for warming the body of a diver;
a battery providing electrical energy for raising the temperature of said element;
a switch interconnecting said battery and said element, said switch being operated by a wireless receiver;
a wireless transmitter remote from said element and operable to transmit an ON/OFF signal to said receiver for selectively closing and opening said switch.

2. The apparatus recited in claim 1 wherein said heater pad element is made of a conductive rubber.

3. The apparatus recited in claim 1 wherein said battery is a Li ion polymer battery.

4. The apparatus recited in claim 3 wherein said battery is no more than 0.25 inches in thickness.

5. The apparatus recited in claim 1 wherein said wireless transmitter is mounted on a wristband.

6. A heater apparatus for use on a wetsuit; the apparatus comprising:
a belt configured for being secured around the waist portion of the wetsuit;
at least one heater pad element position on said belt for warming the body of a diver;
a battery providing electrical energy for raising the temperature of said element;
a switch interconnecting said battery and said element, said switch being operated by a wireless receiver;
a wireless transmitter remote from said element and operable to transmit an ON/OFF signal to said receiver for selectively closing and opening said switch.

7. The apparatus recited in claim 6 wherein said heater pad element is made of a conductive rubber.

8. The apparatus recited in claim 6 wherein said battery is a Li ion polymer battery.

9. The apparatus recited in claim 8 wherein said battery is no more than 0.25 inches in thickness.

10. The apparatus recited in claim 6 wherein said wireless transmitter is mounted on a wristband.
